(19) United States
(12) Patent Application Publication
(10) Pub. No.: US 2014/0067696 A1
(43) Pub. Date: Mar. 6, 2014

(54) SYSTEM AND METHOD FOR AUTOMATICALLY SUBMITTING PRIOR ART

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/956,124

(22) Filed: Jul. 31, 2013

(30) Foreign Application Priority Data
Aug. 30, 2012 (CN) 2012103154483

(51) Int. Cl. G06Q 50/18; G06Q 10/10

(52) U.S. Cl. CPC G06Q 50/184; G06Q 10/10
USPC 705/310

(57) ABSTRACT

In a data processing device for automatically submitting prior art, a computerized method and a non-transitory storage medium are employed. An office action of a patent application A is received, and mentioned prior art is automatically recognized from the office action. Basic information of the mentioned prior art and one or more related patent applications of the patent application A are also obtained. One or more of the related patent applications that are required to be submitted as the mentioned prior art are determined. The basic information of the mentioned prior art is inserted into a generated blank form, and then the completed form is submitted to the patent office.

### BACKGROUND

1. Technical Field

Embodiments of the present disclosure relate to document analysis technologies, and more particularly to a system and a method for automatically submitting prior art to patent offices.

2. Description of Related Art

During the prosecution of patent applications, many applicants search for related or prior art by manually entering search terms. The applicant may search the

Internet or go to specific databases such as the USPTO patent data repository. However, this process is tedious and time consuming. Therefore there is room for improvement.

### BRIEF DESCRIPTION OF THE DRAWINGS

FIG. 1 is a block diagram of one embodiment of a data processing device including a prior art submission system.

FIG. 2 is a block diagram of one embodiment of function modules of the prior art submission system in FIG. 1.

FIG. 3 illustrates a flowchart of one embodiment of a method for automatically submitting prior art.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

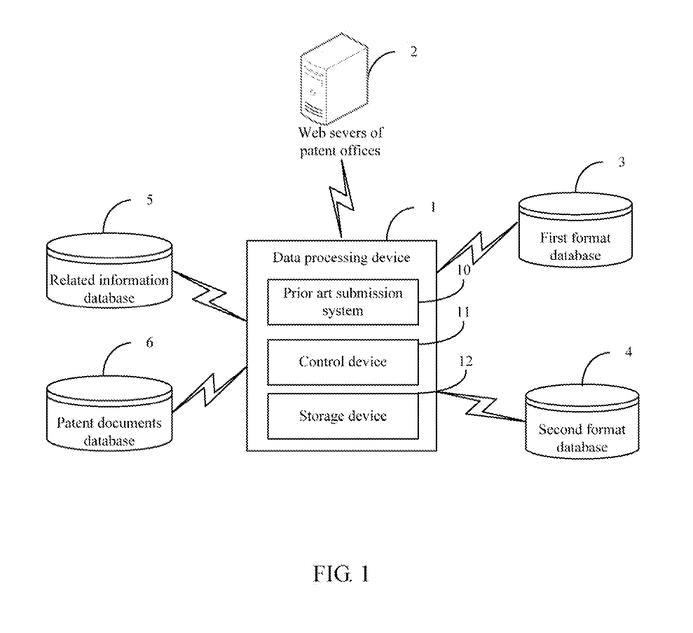

FIG. 1 is a block diagram of one embodiment of a data processing device 1 including a prior art submission system 10. The data processing device 1 may be a computer, a server, or a personal digital assistant (PDA), for example. The data processing device 1 may further include components such as a control device 11 and a storage device 12. The data processing device 1 may be configured in a number of ways and may include other or different components.

The data processing device 1 communicates with web servers 2 of a plurality of patent offices, such as the USPTO, the State Intellectual Property Office (SIPO) of China, the Japan Patent Office (JPO), the World Intellectual Property Organization (WIPO), and so on, via the Internet. In addition, the data processing device 1 connects with a first format database 3, a second format database 4, a related information database 5, and a patent documents database 6 through the Internet or an intranet.

The first format database 3 records names and formats of office actions which may refer to any prior art. The office actions are received from the web servers 2 of the plurality of patent offices. For example, the office actions received from the USPTO may include documents with such names as “Office action,” “Advisory action,” “Notice of allowability,” and so on. However, only the “Office action” may refer to prior art, thus the first format database 3 records the name “Office action.” The format indicates where in the office actions the prior art may be mentioned. For example, in the “Office action” document, the prior art may be mentioned below the characters “Claim Rejections-35 USC §102” or “Claim Rejections-35 USC §103.”

The second format database 4 records number formats of patent documents published or issued by the plurality of patent offices. For example, the number format of a Chinese patent documents may include CNXXXXXXXA, CNXXXXXXXB, CNXXXXXXXC, and so on, where each X indicates an Arabic numeral from 1 to 9.

The related information database 5 records all patent applications in a patent family, and all documents relating to each patent application. The documents relating to a patent application includes office actions received from a patent office and documents made by patent applicants in response to the office actions.

The patent documents database 6 stores basic information of patent documents published or issued by the plurality of patent offices. The basic information includes country codes, such as “CN,” “US,” application dates, application numbers, published/issued date, publication/issue number, inventors, applicants, and image texts, and more.

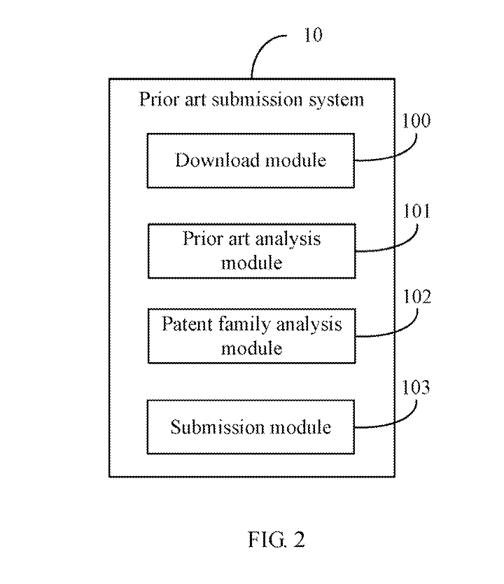

The prior art submission system 10 includes a number of function modules (depicted in FIG. 2). The function modules may include computerized codes in the form of one or more programs, which have functions of automatically submitting prior art to a patent office, such as the USPTO, based on an office action received from a web server 2 of any patent office, such as a SIPO of china, using the first format database 3, the second format database 4, the related information database 5, and the patent documents database 6.

The control device 11 may be a processor, an application-specific integrated circuit (ASIC), or a field programmable gate array, (FPGA) for example. The control device 11 may execute the computerized codes of the function modules of the prior art submission system 10 to realize the functions of the prior art submission system 10.

The storage device 12 may include some type(s) of computer-readable non-transitory storage medium, such as a hard disk drive, a compact disc, a digital video disc, or a tape drive. The storage device 12 stores the computerized code of the function modules of the prior art submission system 10 for execution by the control device 12.

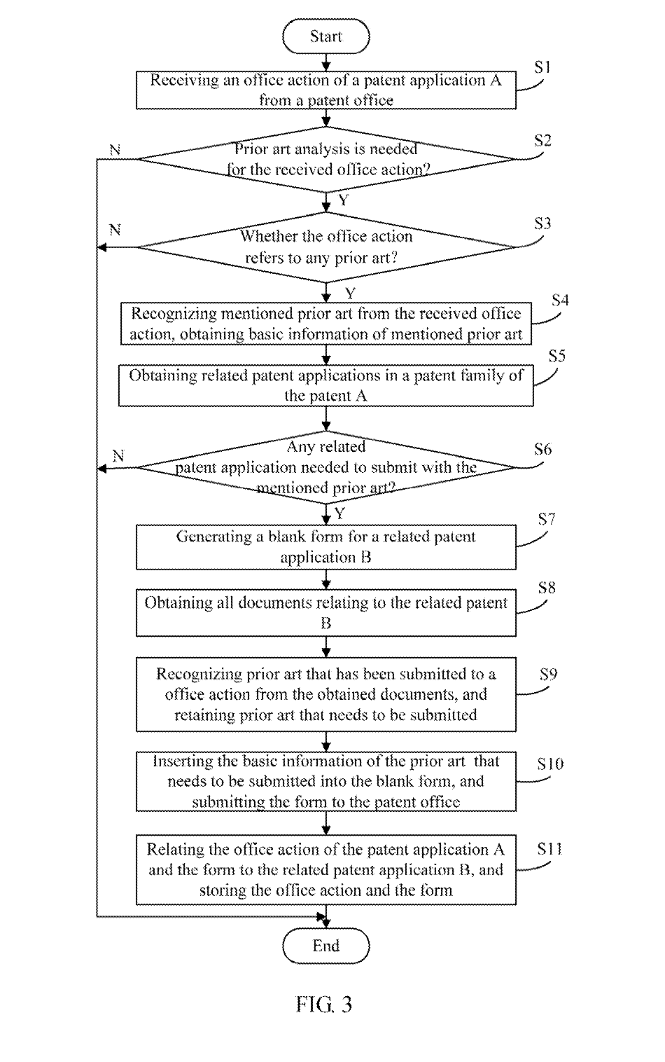

FIG. 2 is a block diagram of one embodiment of function modules of the prior art submission system 10. In one embodiment, the prior art submission system 10 may include a download module 100, a prior art analysis module 101, a patent family analysis module 102, and a submission module 103. The function modules 100 to 103 provide functions needed to execute the steps illustrated in FIG. 3.

FIG. 3 illustrates a flowchart of one embodiment of a method for automatically submitting prior art. In the embodiment, the method is executed by at least one processor of a computer, for example, the control device 11 of the data processing device 1. Depending on the embodiment, additional steps in FIG. 3 may be added, others removed, and the ordering of the steps may be changed.

In step S1, the download module 100 receives an office action of a patent application (patent application A, hereinafter) from a patent office.

In step S2, the prior art analysis module 101 determines whether a prior art analysis is needed for the received office action according to the first format database 3. As mentioned above, the first format database 3 records names of office actions, which may refer to any prior art. If the name of the received office action is recorded in the first format database 3, the prior art analysis module 101 determines that a prior art analysis is needed for the received office action, then step S3 is implemented. If the name of the received office action is not recorded in the first format database 3, the prior art analysis module 101 determines that a prior art analysis is not needed for the received office action, and the procedure ends.

In step S3, the prior art analysis module 101 determines whether the received office action refers to any prior art according to the first format database 3. As mentioned above, the first format database 3 further records formats indicating where in an office action the prior art may be mentioned.

In step S4, prior art analysis module 101 recognizes mentioned prior art from the received office action according to the second format database 4, obtains basic information of the mentioned prior art from the patent document database 6, and stores the basic information of the mentioned prior art into, for example, the storage device 12. The basic information of the mentioned prior art includes country codes, application dates, application numbers, published/issued date, publication/issue number, inventors, applicants, image texts, and more. As mentioned above, the second format database 4 records number formats of patent documents published or issued by the plurality of patent offices. The prior art analysis module 101 compares the received office action with the number formats of patent documents to recognize the mentioned prior art.

In step S5, the patent family analysis module 102 obtains one or more related patent applications in the same patent family with the patent application A from the related information database 5. As mentioned above, the related information database 5 records all patent applications in a patent family, and all documents relating to each patent application. In the embodiment of the patent application A being a CN patent application, the patent family analysis module 102 obtains related patent applications including a U.S. patent application, a JP patent application, and a TW patent application, for example, which are in the same patent family with the application patent A.

In step S6, the patent family analysis module 102 determines whether any of the related patent applications are needed to be submitted with the mentioned prior art. In one embodiment, when the related patent applications include a U.S. patent application, then, the patent family analysis module 102 determines that any of the related patent applications is needed to be submitted with the mentioned prior art, and then step S7 is implemented. Otherwise, when the related patent applications do not include any U.S. patent application, then the patent family analysis module 102 determines that no related patent application is needed to be submitted with mentioned prior art, and the procedure ends.

In step S7, the submission module 103 generates a blank form for a patent application (the patent application B, hereinafter) which is actually a related patent application needing to be submitted with the mentioned prior art, such as the U.S. patent application. In one embodiment, the blank form is a blank Information Disclosure Statement (IDS) form.

In step S8, the submission module 103 obtains all documents connected to patent application B from the related information database 5. The obtained documents connected to the patent application B include office actions received from a patent office and documents which respond to office actions.

In step S9, having obtained the connected documents, the submission module 103 recognizes prior art that has been submitted to the patent office and retains prior art that needs to be submitted from the mentioned prior art according to the prior art that has been submitted. That is, if the mentioned prior art includes a prior art that has been submitted to the patent office, the submission module 103 omits the prior art that has been submitted to the patent office, and the retained prior art are the prior art that needs to be submitted.

In step S10, the submission module 103 inserts the basic information of the prior art that needs to be submitted into the blank form, and submits the completed form to the patent office.

In step S11, the submission module 103 associates the current office action of the patent application A and the completed form relating to the patent application B, and stores the office action and the completed form into the related information database 5.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computerized method for automatically submitting prior art, the method being executed by at least one processor of a data processing device, and the method comprising:
receiving an office action of a patent application A;
automatically recognizing mentioned prior art from the received office action, and obtaining basic information of the mentioned prior art;
obtaining one or more related patent applications which is in a patent family of the patent application A, and determining a related patent application B which is needed to submit the mentioned prior art;
automatically generating a blank form for the related patent application B; and
inserting the basic information of the mentioned prior art into the blank form, and submitting the completed form to a patent office.

2. The method according to claim 1, wherein the data processing device connects to a first format database which records names and formats of office actions which have a possibility of referring to prior art, wherein the formats of the office actions indicate where in the office actions the prior art is mentioned.

3. The method according to claim 2, wherein the recognizing step comprises:
determining whether a prior art analysis is needed for the received office action according to the names of the office actions recorded in the first format database; and
determining whether the received office action refers to prior art according to the formats of the office actions recorded in the first format database, upon condition that prior art analysis is needed for the received office action.

4. The method according to claim 1, wherein the data processing device connects to a second format database which records number formats of patent documents published or issued by a plurality of patent offices.

5. The method according to claim 4, wherein the mentioned prior art is recognized by comparing the received office action with the number formats of patent documents in the second format database.

6. The method according to claim 1, wherein the data processing device connects to a related information database which records all patent applications in a patent family, and all documents relating to each of the patent applications.

7. The method according to claim 6, wherein the inserting step is replaced by the following steps:
obtaining all the documents relating to the related patent application B from the related information database;
recognizing prior art that has been submitted to the patent office from the obtained documents, and retaining prior art that needs to be submitted from the mentioned prior art according to the prior art that has been submitted; and
inserting the basic information of the prior art that needs to be submitted into the blank form, and submitting the complete form to the patent office.

8. A data processing device, comprising:
a control device; and
a storage device storing one or more programs which when executed by the control device, causes the control device to:
receive an office action of a patent application A;
automatically recognize mentioned prior art from the received office action, and obtain basic information of the mentioned prior art;
obtain one or more related patent applications which is in a patent family of the patent application A, and determine a related patent application B which is needed to submit the mentioned prior art;
automatically generate a blank form for the related patent application B; and
insert the basic information of the mentioned prior art into the blank form, and submit the completed form to a patent office.

9. The data processing device according to claim 8, wherein the data processing device connects to a first format database, a second format database, a related information database, and a patent documents database, wherein:
The first format database record names and formats of office actions which have a possibility of referring to prior art, wherein the formats of the office actions indicate where in the office actions the prior art is mentioned;
the second format database records number formats of patent documents published or issued by a plurality of patent offices;
the related information database records all patent applications in a patent family, and all documents relating to each of the patent applications; and
the patent documents database stores basic information of patent documents published or issued by a plurality of patent offices.

10. The data processing device according to claim 9, wherein the one or more programs further causes the control device to:
determine whether a prior art analysis is needed for the received office action according to the names of the office actions recorded in the first format database; and
determine whether the received office action refers to prior art according to the formats of the office actions recorded in the first format database, upon condition that prior art analysis is needed for the received office action.

11. The data processing device according to claim 9, wherein the mentioned prior art is recognized by comparing the received office action with the number formats of patent documents in the second format database.

12. The data processing device according to claim 9, wherein the one or more programs further causes the control device to:
obtain all the documents relating to the related patent application B from the related information database;
recognize prior art that has been submitted to the patent office from the obtained documents, and retain prior art that needs to be submitted from the mentioned prior art according to the prior art that has been submitted; and
insert the basic information of the prior art that needs to be submitted into the blank form, and submitting the complete form to the patent office.

13. A non-transitory storage medium having stored thereon instructions that, when executed by a processor of a data processing device, causes the processor to perform a method for automatically submitting prior art, wherein the method comprises:
receiving an office action of a patent application A;
automatically recognizing mentioned prior art from the received office action, and obtaining basic information of the mentioned prior art;
obtaining one or more related patent applications which is in a patent family of the patent application A, and determining a related patent application B which is needed to submit the mentioned prior art;
automatically generating a blank form for the related patent application B; and
inserting the basic information of the mentioned prior art into the blank form, and submitting the completed form to a patent office.

14. The non-transitory storage medium according to claim 13, wherein the data processing device connects to a first format database which records names and formats of office actions which have a possibility of referring to prior art, wherein the formats of the office actions indicate where in the office actions the prior art is mentioned.

15. The non-transitory storage medium according to claim 14, wherein the recognizing step comprises:
determining whether a prior art analysis is needed for the received office action according to the names of the office actions recorded in the first format database; and
determining whether the received office action refers to prior art according to the formats of the office actions recorded in the first format database, upon condition that prior art analysis is needed for the received office action.

16. The non-transitory storage medium according to claim 13, wherein the data processing device connects to a second format database which records number formats of patent documents published or issued by a plurality of patent offices.

17. The non-transitory storage medium according to claim 16, wherein the mentioned prior art is recognized by comparing the received office action with the number formats of patent documents in the second format database.

18. The non-transitory storage medium according to claim 13, wherein the data processing device connects to a related information database which records all patent applications in a patent family, and all documents relating to each of the patent applications.

19. The non-transitory storage medium according to claim 18, wherein the inserting step is replaced by the following steps:
obtaining all the documents relating to the related patent application B from the related information database;
recognizing prior art that has been submitted to the patent office from the obtained documents, and retaining prior art that needs to be submitted from the mentioned prior art according to the prior art that has been submitted; and
inserting the basic information of the prior art that needs to be submitted into the blank form, and submitting the complete form to the patent office.
